(19) United States
(12) Patent Application Publication
(10) Pub. No.: US 2025/0187453 A1
(43) Pub. Date: Jun. 12, 2025

(54) ELECTRIC VEHICLE (EV) CHARGING METHOD, EV CHARGER, AND EV

(71) Applicant: Mercedes-Benz Group AG, Stuttgart (DE)

(72) Inventors: Tobias GLOSSMANN, Birmingham, MI (US); Sorin PANAINTE, Holland, MI (US)

(21) Appl. No.: 18/530,579

(22) Filed: Dec. 6, 2023

(51) Int. Cl. B60L 53/10; B60L 53/16; B60L 53/22; B60L 53/66; H02J 7/00

(52) U.S. Cl. CPC B60L 53/11; B60L 53/16; B60L 53/22; B60L 53/66; H02J 7/0042; H02J 7/00711; H02J 2207/20

(57) ABSTRACT

An electric vehicle (EV) charger includes a plurality of input connectors configured to receive at least two power supplies; a power processing circuit connected to the plurality of input connectors and configured to process the at least two power supplies to provide at least one of an alternating current (AC) power output or a direct current (DC) power output for charging an EV through a charging connector; and a control circuit configured to control the power processing circuit and communicate with the EV for coordinating the charging of the EV based on the at least one the AC power output or the DC power output.

### TECHNICAL FIELD

The present disclosure relates to the technical field of electric vehicle (EV) charging and, more particularly, to an EV charging method, an EV charger, and an EV.

### BACKGROUND

EVs may be charged at home by a level 1 charger or a level 2 charger. The level 1 charger takes in a 120V alternating current (AC) power supply directly from a household electrical outlet and outputs a 120V AC charging power to charge an EV, which often includes an on-board rectifier circuit to convert the 120V AC charging power into a direct current (DC) charging power to charge a battery of the EV. The level 1 charger is often small and portable, but is slow to charge the EV. The level 2 charger takes in a 120/240V AC power supply from a residential circuit breaker panel and converts the 240V AC power supply into a DC charging power to charge the EV. Although being faster to charge the EV than the level 1 charger, the level 2 charger needs to be installed in a home, which is complicated and costly. The present disclosure provides an EV charger and a EV charging method that are not only fast to charge the EV but also easy to install for home use.

### SUMMARY

One aspect of the present disclosure provides an electric vehicle (EV) charger. The EV charger includes a plurality of input connectors configured to receive at least two power supplies, a power processing circuit connected to the plurality of input connectors and configured to process the at least two power supplies to provide at least one of an alternating current (AC) power output or a direct current (DC) power output for charging an EV through a charging connector, and a control circuit configured to control the power processing circuit of the EV charger and communicate with the EV for coordinating the charging of the EV based on the at least one of the AC power output or the DC power output.

Another aspect of the present disclosure provides an electric vehicle (EV) charging method. The method includes: receiving, by an EV charger, an alternating current (AC) power supply from an electricity supplier; outputting, by the EV charger, an AC power output and a direct current (DC) power output to an EV through a charging connector; and controlling, by the EV charger, a charging mode of the EV to receive the at least one of the AC power output and the DC power output to charge the EV.

Another aspect of the present disclosure provides an electric vehicle (EV). The EV includes a battery, a vehicle inlet configured to receive a charging connector for receiving at least one of an alternating current (AC) power supply or a direct current (DC) power supply, an on-board rectifier circuit capable of converting the received AC power supply into a DC charging power supply, and a charging circuit capable of combining the received DC power supply at the vehicle inlet with the converted DC charging power supply to obtain a combined DC charging power supply for charging the battery, and a control circuit connected to the vehicle inlet, the on-board rectifier circuit, and the charging circuit, and configured to process a pulse width modulation (PWM) signal received from a control pilot (CP) pin of the charging connector to communicate at least one of a first EV charging mode, a second EV charging mode, or a third EV charging mode to the EV. The first duty cycle corresponds to the third EV charging mode for simultaneous AC and DC charging, the second duty cycle corresponds to the first EV charging mode for DC charging, and the third duty cycle corresponds to the second EV charging mode for AC charging.

Other aspects of the present disclosure can be understood by those skilled in the art in light of the description, the claims, and the drawings of the present disclosure.

### BRIEF DESCRIPTION OF THE DRAWINGS

To more clearly illustrate the technical solutions in embodiments of the present disclosure, the drawings used in the description of the disclosed embodiments are briefly described hereinafter. Other drawings may be derived from such drawings by a person with ordinary skill in the art without creative efforts and may be encompassed in the present disclosure.

FIG. 1 illustrates an EV charging arrangement for home use;

FIG. 2 illustrates an exemplary EV charging arrangement for home use according to some embodiments of the present disclosure;

FIG. 3 illustrates a meter connection adapter being installed around an electricity meter according to some embodiments of the present disclosure;

FIG. 4 illustrates another EV charging arrangement for home use according to some embodiments of the present disclosure;

FIG. 5 illustrates a structural schematic diagram of a power processing circuit of an exemplary EV charger according to some embodiments of the present disclosure;

FIG. 6 illustrates a structural schematic diagram of a power processing circuit of an exemplary EV charger having a DC charging power according to some embodiments of the present disclosure;

FIG. 7 illustrates a structural schematic diagram of a power processing circuit of an exemplary EV charger having an AC charging power according to some embodiments of the present disclosure;

FIG. 8 illustrates a structural schematic diagram of a power processing circuit of an exemplary EV charger having simultaneous AC and DC charging powers according to some embodiments of the present disclosure;

FIG. 9 illustrates a schematic diagram showing a pulse width modulation (PWM) signal according to some embodiments of the present disclosure;

FIG. 10 illustrates a schematic diagram showing digital modulation superimposed on a pulse width modulation (PWM) signal according to some embodiments of the present disclosure;

FIG. 11 illustrates a schematic diagram of a CCS1 connector according to some embodiments of the present disclosure;

FIG. 12 illustrates a schematic diagram showing a PWM signal according to some embodiments of the present disclosure;

FIG. 13 illustrates a schematic diagram showing digital modulation superimposed on a PWM signal according to some embodiments of the present disclosure;

FIG. 14 illustrates a control pilot signal according to some embodiments of the present disclosure;

FIG. 15 illustrates a flowchart of an EV charging method according to some embodiments of the present disclosure; and

FIG. 16 illustrates a schematic block diagram of an exemplary control circuit according to some embodiments of the present disclosure.

### DETAILED DESCRIPTION OF THE EMBODIMENTS

Technical solutions of the present disclosure will be described below with reference to the accompanying drawings. It should be understood that the embodiments are provided to enable a more thorough understanding of the present disclosure and to fully convey the scope of the present disclosure to those skilled in the art, and the present disclosure can be implemented in various forms and should not be limited by the embodiments set forth herein.

In the embodiments of the present disclosure, a sentence like “A and B are connected” may include situations where A and B are connected with each other and are in contact with each other or where A and B are connected through another component and without directly contacting with each other. Also, terms such as “first” and “second” are used to distinguish similar objects and are not necessarily used to describe a specific sequence or order.

Electrical vehicles (EVs) can be charged at charging stations. The EV may include a battery, a vehicle charging inlet configured to receive a charging connector for transmitting an alternating current (AC) power supply and a direct current (DC) power supply, an on-board rectifier circuit capable of converting the received AC power supply into a DC charging power supply, and a charging circuit capable of receiving the DC power supply for charging the battery.

An EV charger at the charging stations employs high voltage direct current (DC) charging power to charge the EVs rapidly. For example, the EV charger may be a level 3 charger providing 400 VDC to 900 VDC to deliver up to 350 kW charging power. The level 3 charger requires a direct connection to an electrical power grid, and is found in public charging stations. However, the level 3 charger cannot be installed at home due to restriction of residential electrical infrastructure.

For home use, a level 1 charger or a level 2 charger may be used to charge an EV at home. The level 1 charger connects to a household alternating current (AC) outlet, outputs an AC charging power to charge the EV, and provides up to 2.6 kW of charging capacity. Though it is the slowest way to charge the EV, the level 1 charger is portable and does not require any installation. The level 2 charger provides up to 7.4 kW with a single-phase AC power supply and 11 kW with a three-phase AC power supply. To obtain the level 2 charger capacity, the level 2 charger needs to be installed at home. The installation of the level 2 charger includes costly upgrade of a residential circuit breaker panel and electrical wiring at home when the level 2 charger provides more than 9kW. The present disclosure provides a faster EV charging system with a charger and charging method without the need for the costly upgrade and potentially a faster home charging solution.

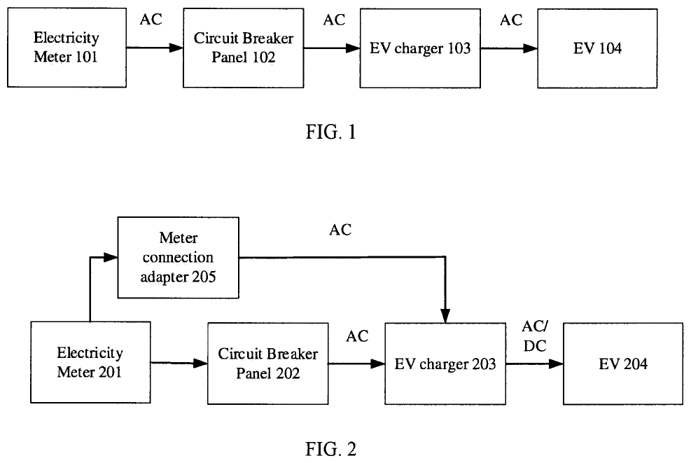

FIG. 1 illustrates an EV charging arrangement for home use. As shown in FIG. 1, in a residential setting, an electricity meter 101 is provided by a utility supplier to connect to a residential electricity grid. A circuit breaker panel 102 is installed at home to safely distribute electricity to various parts of a home. The circuit breaker panel 102 includes a plurality of circuit breakers that provide over-current protection. The EV charger 103 may be a level 1 EV charger or a level 2 EV charger. The level 2 charger is installed at home to connect to the circuit breaker panel 102. When the level 2 charger is installed, the circuit breaker panel 102 also needs costly upgrade to accommodate high power capacity of the level 2 charger. The EV charger 103 includes a charging connector that can be inserted into an inlet of the EV 104 that needs to be charged.

The present disclosure provides an EV charging method and an EV charger. In some embodiments, the disclosed EV charger may increase charging capacity and shorten charging time without costly upgrade of electricity distribution in a home of an EV user.

EVs can be charged at commercial charging stations or at home. EV users are more likely to charge their EVs at home due to the following reasons. Depending on the charging capacity at the commercial charging stations, fully charging an EV may take tens of minutes or hours. Charging the EV at home avoids long wait at public charging stations. In addition, electricity rates at the public charging stations are usually substantially higher than electricity rates at home. Charging the EV at home saves money. Further, some electricity suppliers offer cheap off-peak electricity rates to their residential customers to charge their EVs at home. On the other hand, the coverage of public charging stations is still limited. It may be inconvenient for EV users to drive their EVs to the public charging stations for EV charging. Therefore, charging EVs at home is convenient and cost-effective for most EV users.

An EV may be charged at home in one of the following ways. The EV may be charged using a level 1 charger. In this case, there is no need to upgrade electricity distribution structure at home. However, it takes days to fully charge the EV using the level 1 charger. The EV may also be charged using a level 2 charger. The level 2 charger has substantially higher capacity than the level 1 charger. In this case, the electricity distribution structure at home needs to be upgraded. The upgrade may include replacing an existing circuit breaker panel or adding addition circuit breakers to the existing circuit breaker panel, installing the level 2 charger at a car garage, and installing heavy-duty electrical wires between the existing circuit breaker panel and the installed level 2 charger. The upgrade has to be performed by a licensed electrician and a permit for the upgrade often needs to be obtained from local township government. As a result, installing the level 2 charger at home requires costly electrical upgrade at home. An EV charger for home use that has the charging capacity of the level 2 charger but does not require the costly upgrade will solve the above problem for EV charging at home.

FIG. 2 illustrates an exemplary EV charging arrangement for home use according to embodiments of the present disclosure. An electricity meter 201 is provided by a utility supplier to connect to a residential electricity grid. A circuit breaker panel 202 is installed at home to safely distribute electricity to various parts of a home. The circuit breaker panel 202 may include a plurality of circuit breakers that provide over-current protection. The EV charger 203 may be a level 1 EV charger or a level 2 EV charger. The level 2 charger may be installed at home to connect to the circuit breaker panel 202, and the EV charger 203 includes a charging connector that can be inserted into an inlet of the EV 204 that needs to be charged.

As shown in FIG. 2, a meter connection adapter 205 is connected to the electricity meter 201. The meter connection adapter 205 taps into the electricity meter 201 to support EV charging energy demand without the costly upgrade of existing electricity distribution infrastructure at home. For example, the meter connection adapter 205 may be a collar-like device as shown or another comparable device to support the EV charging energy demand.

FIG. 3 illustrates a meter connection adapter 303 such as a meter collar adapter being connected to an electricity meter according to some embodiments of the present disclosure. Being widely used for applications such as residential solar power generation and diesel backup power generation, etc., the meter connection adapter 303 is easy to install, safe to operate, and cost competitive.

As shown in FIG. 3, the electricity meter includes a meter base 301 and a meter head 302. The meter connection adapter 303 connect to the meter head 302 or the meter head base 301 to extract electrical energy from the electricity meter. For example, the meter connection adapter 303 may wrap around the electricity meter head 302. The extracted electrical energy is outputted by a meter connection adapter cable 304.

In some embodiments, as shown in FIG. 2, the EV charger 203 accepts one AC power supply from the circuit breaker panel 202 and another AC power supply from the meter connection adapter 205, and the EV charger 203 may provide one AC power output, one DC power output, or both AC power output and DC power output for charging the EV 204. As such, more input power enters the EV charger 203, and more output power exits the EV charger 203. The EV 204 often includes an on-board rectifier circuit to convert an AC power into a DC power. When the EV charger 203 outputs both AC power and DC power to simultaneously charge the EV 204, the on-board rectifier circuit converts the AC power into an internal DC power that is combined with the inputted DC power to charge the EV 204 by a charging circuit (not shown). In this way, charging capacity of the EV charger 203 is increased without the costly upgrade of the circuit breaker panel 202.

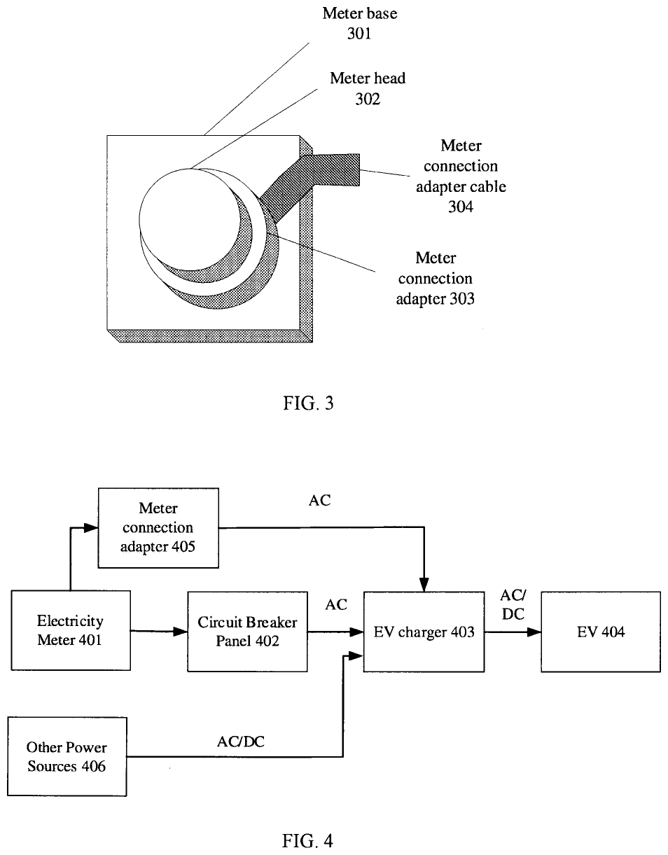

FIG. 4 illustrates another EV charging arrangement for home use according to some embodiments of the present disclosure. In addition to an EV charger 403 receiving AC power from the electricity meter 401 via a meter connection adapter 405 and a circuit breaker panel 402, the EV charger 403 may receive power from other comparable sources. In some embodiments, as shown in FIG. 4, the EV charger 403 may receive other power sources 406 as inputs. The other power sources 406 may include household power supplies from a solar photovoltaic (PV) cell, a fossil fuel generator, a wind-based generator, and a geothermal generator. The other power sources 406 may supply AC power or DC power to the EV charger 403. For example, a solar power generation system with battery storage may supply a DC power to the EV charger 403. This allows renewable power sources to be connected to the EV charger 403 to boost its charging capacity.

In the embodiments of the present disclosure, the EV charger 403 takes a plurality of household power sources as inputs to consolidate various power supplies. It not only boosts the charging capacity of the EV charger 403, but also provides backup in case the electricity grid fails.

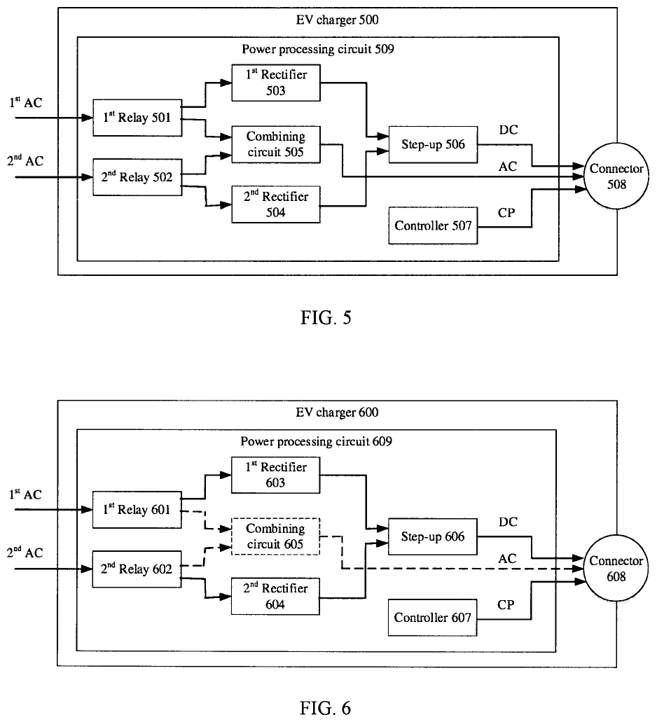

FIG. 5 illustrates a structural schematic diagram of a power processing circuit 509 of an exemplary EV charger 500 according to some embodiments of the present disclosure. As shown in FIG. 5, the EV charger 500 receives a first AC power supply and a second AC power supply, and a controller 507 provides a control pilot (CP) signal to the connector 508. The EV charger 500 provides at least one of a DC power output from the step-up circuit 506 or an AC power output from a combining circuit 505 for charging an EV through a charging connector 508. The first AC power supply is connected to a first relay circuit 501, and the second AC power supply is connected to a second relay circuit 502. The first relay circuit 501, the second relay circuit 502, and the combining circuit 505 enable the EV charger 500 to operate in various EV charging modes. For example, in a hybrid (DC and AC) mode, the connector 508 may receive power from the combining circuit 505 and the step-up circuit 506. The combining circuit 505 may enable one of the first AC power supply or the second AC power supply to generate AC power. DC power may be generated from the first rectifier 503 and the second rectifier 504 based on one of the first AC power supply or the second AC power supply via the respective rectifier circuit (e.g., first rectifier circuit 503 or second rectifier circuit 504). The step-up circuit 506 may receive the DC power from the first rectifier circuit 503 and/or the second rectifier circuit 504.

In some embodiments, the EV charger may include an internal control circuit such as the controller 507 or an external control circuit that may be located in the EV. As shown in FIG. 5, the controller 507 may monitor status of the first AC power supply, the second AC power supply, the first relay circuit 501, the second relay circuit 502, the first rectifier circuit 503, the second rectifier circuit 504, the combining circuit 505, and other components of the EV charger 500. The controller 507 may also receive control commands from a user of the EV charger 500. Based on the status and the control commands, the controller 507 may control the EV charger and/or the EV for charging through the CP signal through a CP pin of the charging connector 508.

In some embodiments, the first AC power supply comes from an electricity meter through a meter connection adapter and the second AC power supply comes from a circuit breaker panel that is connected to the electricity meter. In some other embodiments, the second AC power supply comes from the electricity meter through the meter connection adapter and the first AC power supply comes from the circuit breaker panel that is connected to the electricity meter.

In some embodiments, as shown in FIG. 6, the EV charger 600 operates in a first EV charging mode with the power processing circuit 609, and a controller 607 of the EV charger 600 provides a control pilot (CP) signal to the connector 608. Connections and functional blocks shown in dashed lines are disabled such as a combining circuit 605 which may provide AC power to a charging connector 608. In the first EV charging mode, the first relay circuit 601 is connected to a first rectifier circuit 603, and the second relay circuit 602 is connected to a second rectifier circuit 604. The first rectifier circuit 603 converts the first AC power supply into a first DC power supply, and the second rectifier circuit 604 converts the second AC power supply into a second DC power supply. The first DC power supply and the second DC power supply are inputted into a step-up circuit 606. The step-up circuit 606 combines the first DC power supply and the second DC power supply into a high voltage DC power supply. The high voltage DC power supply is provided to charge the EV through the charging connector 608.

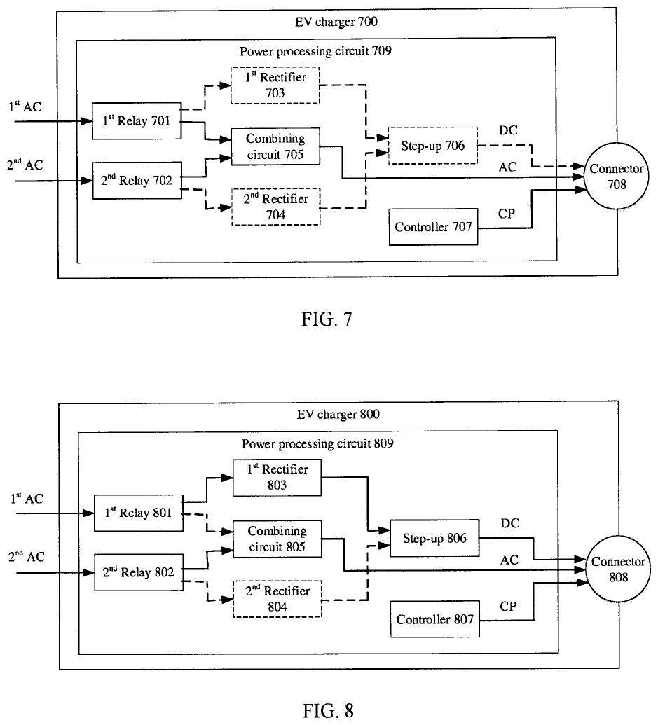

In some embodiments, as shown in FIG. 7, the EV charger 700 operates in a second EV charging mode with the power processing circuit 709. The controller 707 of the EV charger 700 provides a control pilot (CP) signal to a charging connector 708. Connections and functional blocks shown in dashed lines are disabled such as a first rectifier 703, a second rectifier 704, and the step-up circuit 706 that may provide DC power to the charging connector 708. In the second EV charging mode, the first relay circuit 701 and the second relay circuit 702 are connected to a combing circuit 705. The combining circuit 705 combines the first AC power supply and the second AC power supply into a combined AC power supply. The combined AC power supply is provided to charge the EV through the charging connector 708.

In some embodiments, as shown in FIG. 8, the EV charger 800 operates in a third EV charging mode with the power processing circuit 809. The controller 807 of the EV charger 800 provides a control pilot (CP) signal to a charging connector 808. Connections and functional blocks shown in dashed lines are disabled such as a second rectifier 804. In the third EV charging mode, the first relay circuit 801 is connected to the first rectifier circuit 803, and the second relay circuit 802 is connected to the combining circuit 805. On one hand, the first rectifier circuit 803 converts the first AC power supply into the first DC power supply. The first DC power supply is inputted into the step-up circuit 806. The step-up circuit 806 steps up the first DC power supply into the high voltage DC power supply. On the other hand, the combining circuit 805 relays the second AC power supply to the charging connector 808. Both the high voltage DC power supply and the second AC power supply are provided to simultaneously charge the EV through the charging connector 808.

In some embodiments, the EV charger further includes a display (not shown). The display may be a touch-control display. The user may enter the control commands through the display. For example, the user can configure the EV charger to operate in one of the first, the second, the third, or another comparable EV charging modes. Through the display, the user may view the status of the first AC power supply, the second AC power supply, the first relay circuit, the second relay circuit, the first rectifier circuit, the second rectifier circuit, and the combining circuit.

In some embodiments, the controller or control circuit may also receive EV status through the CP pin. Based on the EV status, the control circuit may determine that the EV supports, and the user will be limited to the EV charging modes that the EV supports. For example, the EV supports may support EV charging through either the AC power output or the DC power output, that is, the first and the second EV charging modes. In another example, the EV supports simultaneously EV charging through both the AC power output and the DC power output, that is, the third EV charging mode.

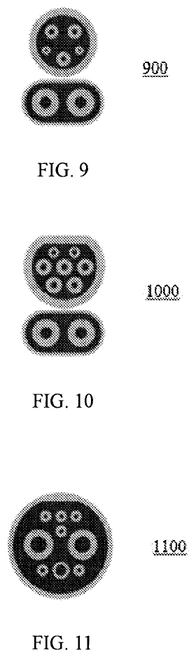

In some embodiments, the charging connector may be an AC charging connector or a DC charging connector. When the EV charger is equipped only with the AC charging connector, the EV charger may support the second EV charging mode. For example, the AC charging connector may be a J1722 (type 1) connector for North America and Japan, a Mennekes (type 2) connector for Europe, a GB/T AC connector for China, or other suitable connectors. When the EV charger is equipped with the DC charging connector, the EV charger supports the first, the second, and the third EV charging modes. This is because the DC charging connector often provides connection pins for both the AC power output and the DC power output. For example, the DC charging connector may be a CCS1 connector 900 for North America, a CCS2 connector 1000 for Europe, or a GB/T DC connector 1100 for China, as shown in FIG. 9, FIG. 10, and FIG. 11, respectively. These connectors provide connection pins for both the AC power output and the DC power output.

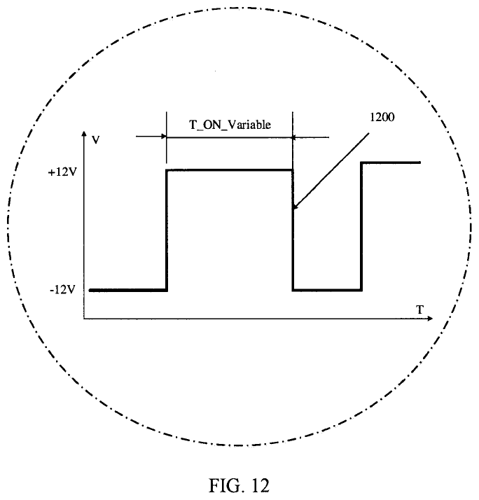

In some embodiments, the charging connector includes the CP pin carrying the CP signal 1200 as shown in FIG. 12 to and from the EV. The CP signal 1200 is a 1 kHz pulse width modulated (PWM) signal at +12V, and the CP signal may be used to detect the presence of the EV, communicate a charging mode, communicate a charging level and charging current between the EV charger and the EV, and control charging start and end. The CP signal 1200 may be used to detect an AC charging mode based on the variable PWM signal.

In some embodiments, the control circuit of the EV charger or the EV may control the EV to accept both the AC power output and the DC power output for simultaneous charging by sending a PWM signal with a first duty cycle through the CP pin of the charging connector. Due to signal loss and distortion at the charging connector, the CP signal at the EV charger side and the CP signal at the EV side may be slightly different. For example, the first duty cycle is about 8% for simultaneous charging. At an inlet of the EV, a duty cycle between 7.5% and 8.5% is determined to be the first duty cycle.

In some embodiments, the control circuit of the EV charger or of the EV may control the EV to enable digital communication for adjusting the charging mode by sending the PWM signal with a second duty cycle different from the first duty cycle through the CP pin of the charging connector. For example, the second duty cycle is about 5%. At the inlet of the EV, a duty cycle between 4.5% and 5.5% is determined to be the second duty cycle.

In some embodiments, if the duty cycle of the CP signal=0% at the EV charger side and <3% at the EV side, no charging is allowed. If the duty cycle of the CP signal is between 6% and 7% at the EV side, no charging is allowed. If the duty cycle of the CP signal=100% at the EV charger side, no charging is allowed.

The second EV charging mode from FIG. 7 for AC charging corresponds to a third duty cycle, which is in the range of 10-96.5%. If the duty cycle of the CP signal is between 10% and 20% at the EV charger side and between 10% and 20% at the EV side, a maximum charging current=duty cycle×0.6 A. If the duty cycle of the CP signal is between 20% and 85% at the EV charger side and between 20% and 85% at the EV side, a maximum charging current=duty cycle×0.6 A. If the duty cycle of the CP signal is between 85% and 96% at the EV charger side and between 85% and 96% at the EV side, a maximum charging current=(duty cycle−64)×0.6 A. If the duty cycle of the CP signal is between 96% and 96.5% at the EV side, a maximum charging current=80 A. The maximum charging current for AC charging may be transmitted via the PWM duty cycle of the CP signal, and the maximum charging current for DC charging may be transmitted via a power line carrier communication.

For the simultaneous AC and DC charging, initially, the PWM signal has a fixed duty cycle to communicate the maximum current for DC charging through the power line carrier communication. Then, the PWM signal changes its duty cycle to a variable duty cycle indicating AC charging to communicate the maximum current for AC charging. The PWM signal will then switch to another fixed duty cycle corresponding to simultaneous AC and DC charging to maintain simultaneous AC and DC charging. In addition, other charging parameters such as a minimum charging current, a charging voltage, etc., may also be communicated through the power line carrier communication.

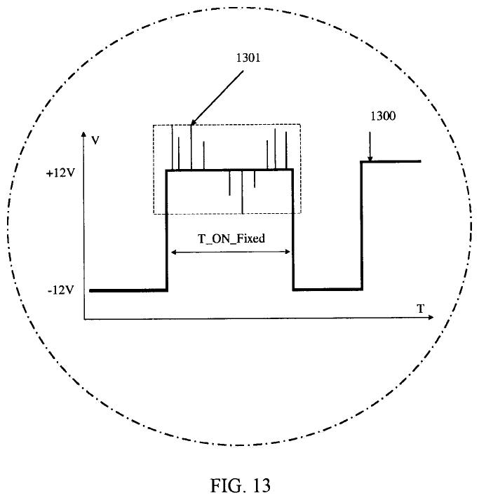

In some embodiments, the control circuit of the EV charger and the EV digitally communicate with each other through the PWM signal 1300 that may include a modulated, high-frequency signal 1301 over the PWM signal 1300 for indicating a DC charging mode, as shown in FIG. 13. The CP signal 1300 may be a 1 kHz pulse width modulated (PWM) signal. The CP signal 1300 may be used to detect a DC charging mode based on the fixed PWM signal with the high-frequency signal 1301.

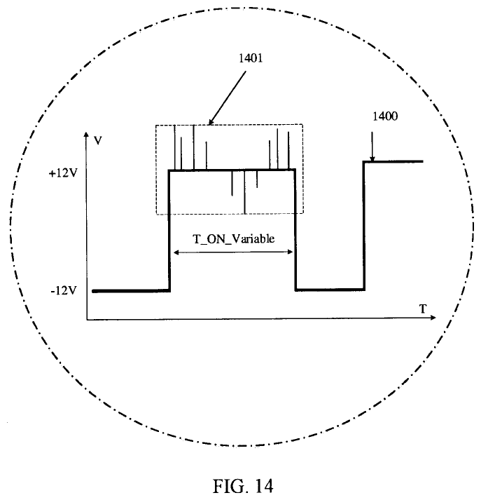

In some embodiments, a CP signal 1400, as shown in FIG. 14, may include a combination of the CP signal 1200, CP signal 1300, and high-frequency signal 1301 for indicating an AC & DC charging mode.

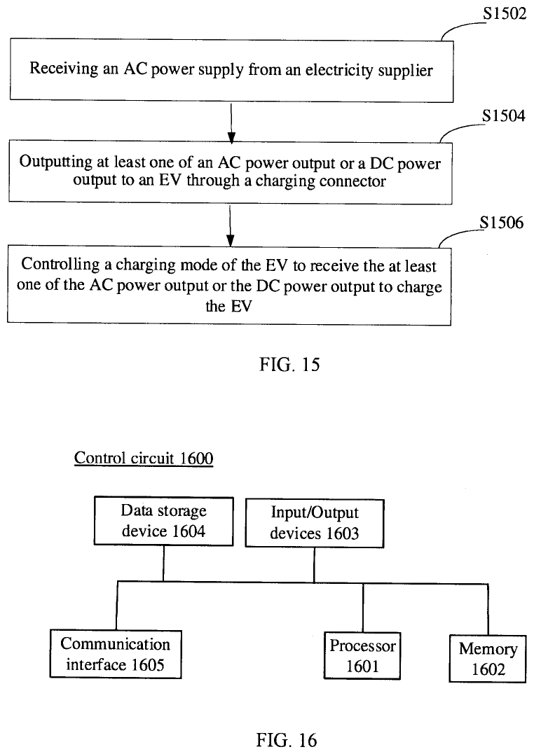

The present disclosure further provides an EV charging method. FIG. 15 illustrates a flowchart of an EV charging method according to some embodiments of the present disclosure. The EV charging method includes the following processes.

At S1502, an AC power supply is received by an EV charger from an electricity supplier.

Specifically, the AC power supply may include a first AC power supply and a second AC power supply. The first AC power supply comes from an electricity meter and the second AC power supply comes from a circuit breaker panel that is connected to the electricity meter.

At S1504, at least one of an AC power output or a DC power output are outputted by the EV charger to an EV through a charging connector.

Specifically, the EV charger outputs that at least one of the AC power output or the DC power output to the EV corresponding to one of the EV charging modes. The charging mode includes a first EV charging mode for DC charging, a second EV charging mode for AC charging, and a third charging mode for AC and DC charging. The first EV charging mode from FIG. 6 for DC charging corresponds to the second duty cycle. The second EV charging mode from FIG. 7 for AC charging corresponds to the third duty cycle, which is in the range of 10-96.5%. The third EV charging mode from FIG. 8 for AC and DC charging corresponds to the first duty cycle.

At S1506, the EV is controlled by the EV charger to receive the at least one of the AC power output or the DC power output to charge the EV. For example, the EV may receive both the AC power output and the DC power output to simultaneously charge the EV based on the third EV charging mode.

Specifically, controlling the EV to receive the at least one of the AC power output or the DC power output to charge the EV may include sending, by the EV charger, a pulse width modulation (PWM) signal with a first duty cycle to the EV through a control pilot (CP) pin of the charging connector. For example, the first duty cycle is about 8% and corresponds to the third EV charging mode for simultaneous AC and DC charging. At a vehicle inlet of the EV, a duty cycle between 7.5% and 8.5% is determined to be the first duty cycle.

The PWM signal with the second duty cycle of 5% is the first EV charging mode for DC charging. In this charging mode, the EV charger communicates charging parameters such as maximum charging current to the EV through a mechanism, for example, a digital communication protocol (i.e., a high frequency content or a high frequency signal) as shown in FIG. 13. The PWM signal with the third duty cycle between 10% and 96.5% is a charging mode for AC charging. This second EV charging mode may have variable duty cycles. The EV charger communicates the charging parameters such as the maximum charging current to the EV by different duty cycles of the PWM signal. The different duty cycles are used to indicate the maximum charging current values.

In the embodiments of the present disclosure, the EV charger for home use receives a plurality of AC and/or DC power supplies to boost its charging capacity. The meter connection adapter is used to tap into the AC power directly from the household electricity meter without the costly upgrade to the circuit breaker panel. The EV charger may provide both the AC power output and the DC power output to simultaneously charge the EV, thereby shortening EV charging time in a residential environment.

FIG. 16 illustrates a schematic block diagram of an exemplary control circuit according to some embodiments of the present disclosure. The control circuit may be located in the EV charger, in the EV, or both. If there are at least two control circuits, the control circuits may coordinate with each other to implement the steps of the present disclosure.

The PWM signal from the EV charger has a defined duty cycle initially that may determine the type of charging operations (i.e., charging modes) such as no charging, DC charging, AC & DC charging, or AC charging. Based on the duty cycle value and acknowledgment from the EV, the control circuit may control the on-board rectifier circuit to convert or not the received AC input to DC and combine with the other input sources. After the identification of a first duty cycle value, the charging could be a hybrid-type charging of AC and DC, or after the identification of a second duty cycle, the charging could be DC. The control circuit may detect a third duty cycle value for AC charging.

For example, the control circuit of the EV may detect the charging mode of the EV charger after the charging connector is inserted into the EV. The control circuit of the EV may detect at least three PWM duty cycle values for identifying the charging mode. The control circuit from the EV charger may generate the control pilot (CP) signal such as a variable PWM signal for AC charging, a fixed PWM signal for DC charging, or a combination of PWM signal for AC & DC charging.

Controlling the EV to receive the AC power output and the DC power output to simultaneously charge the EV may include sending, by the EV charger, a pulse width modulation (PWM) signal with a first duty cycle to the EV through a control pilot (CP) pin of the charging connector. For example, the first duty cycle is about 8%. At a vehicle inlet of the EV, a duty cycle between 7.5% and 8.5% is determined to be the first duty cycle. Then, the control circuit may control the on-board rectifier circuit to convert the received AC power supply to the DC charging power supply and may control the charging circuit to combine the received DC power supply with the converted DC charging power supply to obtain the combined DC charging power supply to charge the battery.

Additionally, the control circuit of the EV system may detect that the PWM signal has a second duty cycle of about 5%, and the control circuit of the EV may enable the EV to digitally communicate with the EV charger through the PWM signal. At a vehicle inlet of the EV, a duty cycle between 4.5% and 5.5% is determined to be the second duty cycle. If the control circuit detects the second duty cycle, DC charging may be enabled, and the control circuit may control the on-board rectifier circuit to convert the received AC power supply to the DC charging power supply and may control the charging circuit to charge the battery with the DC charging power supply.

In some embodiments, the control circuit of the EV may detect a third duty cycle from the PWM signal, and the control circuit may control the charging circuit to charge the battery with the received AC power supply. For AC charging, the PWM signal may be variable, and the third duty cycle is in the range of 10-96.5%.

In certain embodiments, the control circuit of the EV may detect another duty cycle. If the charging system's duty cycle is 0% or 100%, there is no charging. If the duty cycle at the vehicle inlet is in the following range or 0-3% or 6-7%, there is no charging.

As shown in FIG. 16, the control circuit 1600 may include a memory 1602, a processor 1601, a communication interface 1605, input/output devices 1603, a data storage device 1604, and other components. Other devices may also be included. The processor 1601 may include any appropriate hardware processor or processors. Further, the processor 1601 can include multiple cores for multi-thread or parallel processing and can include graphics capability for processing for a human-machine interface (HMI) (i.e., an example of input/output devices). The memory 1602 may include any appropriate memory modules, such as ROM, RAM, flash memory modules, and erasable and rewritable memory, and mass storages, such as CD-ROM, DVD, U-disk, and hard disk, etc. The memory 1602 may store computer program instructions or program modules for implementing various processes, when executed by the processor 1601, to perform the EV charging method shown in FIG. 15.

Further, the control circuit 1600 may include a display (not shown). The display may be any suitable display technology suitable to display an image or a video. For example, the display may include a liquid crystal display (LCD) screen, an organic light-emitting diode (OLED) screen, or the like, and may be a touch screen. The communication interface 1605 may include certain network interface devices for establishing connections with the EV. The input/output devices 1603 may include any appropriate input devices to input information to the processor and/or output devices to output information from the processor 1601, such as sensors, etc. Further, the data storage device 1604 may include one or more data stores for storing certain data and for performing certain operations on the stored data, such as EV charging history information, etc.

In the embodiments of the present disclosure, the EV charger for home use receives a plurality of AC and/or DC power supplies to boost its charging capacity. The meter connection adapter is used to tap into the AC power directly from the household electricity meter without the costly upgrade to the circuit breaker panel. The EV charger may provide both the AC power output and the DC power output to simultaneously charge the EV, thereby shortening EV charging time in a residential environment.

The foregoing embodiments describe in detail the objective, the technical solution, and the beneficial effect of the present disclosure. The foregoing disclosed embodiments are only some of the embodiments of the present disclosure rather than all of the embodiments of the present disclosure, which should not be used to limit the scope of present disclosure. Other embodiments obtained by those having ordinary skills in the art on the basis of the described embodiments without inventive efforts should fall within the scope of the present disclosure. Further, under circumstances of no conflict, embodiments and features in the embodiments may be combined with each other. Therefore, any changes, equivalent replacements, and modifications made according to the present disclosure still fall within the scope of the present disclosure.

What is claimed is:

1. An electric vehicle (EV) charger, comprising:
a plurality of input connectors configured to receive at least two power supplies;
a power processing circuit connected to the plurality of input connectors and configured to process the at least two power supplies to provide at least one of an alternating current (AC) power output or a direct current (DC) power output for charging an EV through a charging connector; and
a control circuit configured to control the power processing circuit and communicate with the EV for coordinating the charging of the EV based on the at least one of the AC power output or the DC power output.

2. The EV charger according to claim 1, wherein:
the at least two power supplies include household power supplies from an electricity meter, a circuit breaker panel that is connected to the electricity meter, a solar photovoltaic (PV) cell, a fossil fuel generator, a wind-based generator, and a geothermal generator.

3. The EV charger according to claim 1, wherein:
the at least two power supplies include an AC power supply, a DC power supply, or a combination thereof; and
the at least one electrical power output for the charging comprises a DC power output, an AC power output, or a combination thereof.

4. The EV charger according to claim 3, wherein:
the at least two power supplies include a first AC power supply and a second AC power supply.

5. The EV charger according to claim 4, wherein:
the power processing circuit processes the first AC power supply and the second AC power supply to provide the AC power output for charging the EV through the charging connector.

6. The EV charger according to claim 4, wherein:
the power processing circuit processes the first AC power supply and the second AC power supply to provide the DC power output for charging the EV through the charging connector.

7. The EV charger according to claim 4, wherein:
the power processing circuit processes the first AC power supply and the second AC power supply to provide both the AC power output and the DC power output for simultaneously charging the EV through the charging connector.

8. The EV charger according to claim 4, wherein:
the control circuit communicates with the EV for coordinating the charging of the EV through a control pilot (CP) pin of the charging connector; and
the control circuit sends a pulse width modulation (PWM) signal corresponding to at least one of a first duty cycle, a second duty cycle, or a third duty cycle through the CP pin of the charging connector to communicate at least one of a first EV charging mode, a second EV charging mode, or a third EV charging mode to the EV,
wherein the first duty cycle corresponds to the third EV charging mode for simultaneous AC and DC charging, the second duty cycle corresponds to the first EV charging mode for DC charging, and the third duty cycle corresponds to the second EV charging mode for AC charging.

9. The EV charger according to claim 8, wherein:
the EV charger communicates one or more charging parameters to the EV using the PWM signal through the CP pin, wherein the charging parameters comprise at least one of the first EV charging mode, the second EV charging mode, or the third EV charging mode,
wherein the first EV charging mode comprises at least one of the second duty cycle, a voltage of the PWM signal, or a digital communication signal superimposed on the PWM signal, the second EV charging mode comprises at least one of the third duty cycle, the voltage of the PWM signal, or the digital communication signal superimposed on the PWM signal, or the third EV charging mode comprises at least one of the first duty cycle, the voltage of the PWM signal, or the digital communication signal superimposed on the PWM signal to communicate the maximum charging current to the EV.

10. The EV charger according to claim 8, wherein providing the at least one of the AC power output or the DC power output for charging the EV through the charging connector comprises:
connecting at least one of the first AC power supply or the second AC power supply to a relay circuit to output the AC power output for the second EV charging mode; or
connecting at least one of the first AC power supply or the second AC power supply to a rectifier circuit to an intermediate DC power output, and connecting the intermediate DC power output to a step-up circuit to output the DC power output for the first EV charging mode.

11. The EV charger according to claim 8, wherein providing the at least one of the AC power output or the DC power output for charging the EV through the charging connector comprises:
connecting the second AC power supply to the relay circuit to output the AC power output, connecting the first AC power supply to the relay circuit and to the rectifier circuit to output an intermediate DC power output; and
connecting the intermediate DC power output to the step-up circuit output the DC power output for the third EV charging mode.

12. The EV charger according to claim 4, wherein:
the first AC power supply comes from an electricity meter and the second AC power supply comes from a circuit breaker panel that is connected to the electricity meter; or
the second AC power supply comes from the electricity meter and the first AC power supply comes from the circuit breaker panel that is connected to the electricity meter.

13. The EV charger according to claim 12, wherein:
the AC power supply from the electricity meter is obtained through a meter connection adaptor.

14. An electric vehicle (EV) charging method, comprising:
receiving, by an EV charger, an alternating current (AC) power supply from an electricity supplier;
outputting, by the EV charger, at least one of an AC power output or a direct current (DC) power output to an EV through a charging connector; and
controlling, by the EV charger, a charging mode of the EV to receive the at least one of the AC power output or the DC power output to charge the EV.

15. The EV charging method according to claim 14, wherein:
the AC power supply comprises a first AC power supply from an electricity meter and a second AC power supply from a circuit breaker panel that is connected to the electricity meter.

16. The EV charging method according to claim 15, wherein outputting the at least one of the AC power output or the DC power output to the EV through the charging connector comprises:
connecting at least one of the first AC power supply or the second AC power supply to a relay circuit to output the AC power output for the second EV charging mode; or
connecting at least one of the first AC power supply or the second AC power supply to a rectifier circuit to an intermediate DC power output, and connecting the intermediate DC power output to a step-up circuit to output the DC power output for the first EV charging mode.

17. The EV charging method according to claim 15, wherein outputting the at least one of the AC power output or the DC power output to the EV through the charging connector comprises:
connecting the second AC power supply to the relay circuit to output the AC power output, connecting the first AC power supply to the relay circuit and to the rectifier circuit to output an intermediate DC power output; and
connecting the intermediate DC power output to the step-up circuit output the DC power output for the third EV charging mode.

18. The EV charging method according to claim 16, wherein controlling the EV to receive at least one of the AC power output or the DC power output to charge the EV through the charging connector comprises:
sending, by the EV charger, a pulse width modulation (PWM) signal corresponding to at least one of a first duty cycle, a second duty cycle, or a third duty cycle through the CP pin of the charging connector to communicate at least one of the first EV charging mode, the second EV charging mode, or third EV charging mode to the EV,
wherein the first duty cycle corresponds to the third EV charging mode for simultaneous AC and DC charging, the second duty cycle corresponds to the first EV charging mode for DC charging, and the third duty cycle corresponds to the second EV charging mode for AC charging.

19. The EV charging method according to claim 17, wherein controlling the EV to receive at least one of the AC power output or the DC power output to charge the EV through the charging connector comprises:
sending, by the EV charger, a pulse width modulation (PWM) signal corresponding to at least one of a first duty cycle, a second duty cycle, or a third duty cycle through the CP pin of the charging connector to communicate at least one of the first EV charging mode, the second EV charging mode, or third EV charging mode to the EV,
wherein the first duty cycle corresponds to the third EV charging mode for simultaneous AC and DC charging, the second duty cycle corresponds to the first EV charging mode for DC charging, and the third duty cycle corresponds to the second EV charging mode for AC charging.

20. An electric vehicle (EV), comprising:
a battery;
a vehicle inlet configured to receive a charging connector of an EV charger for receiving at least one of an alternating current (AC) power supply or a direct current (DC) power supply;
an on-board rectifier circuit capable of converting the received AC power supply into a DC charging power supply;
a charging circuit capable of combining the received DC power supply at the vehicle inlet with the converted DC charging power supply to obtain a combined DC charging power supply for charging the battery; and
a control circuit connected to the vehicle inlet, the on-board rectifier circuit, and the charging circuit, and configured to process a pulse width modulation (PWM) signal corresponding to at least one of a first duty cycle, a second duty cycle, or a third duty cycle through a control pilot (CP) pin of the charging connector to communicate at least one of a first EV charging mode, a second EV charging mode, or a third EV charging mode to the EV,
wherein the first duty cycle corresponds to the third EV charging mode for simultaneous AC and DC charging, the second duty cycle corresponds to the first EV charging mode for DC charging, and the third duty cycle corresponds to the second EV charging mode for AC charging.
